(19) United States
(12) Patent Application Publication
(10) Pub. No.: US 2026/0185198 A1
(43) Pub. Date: Jul. 2, 2026

(54) Cold rolled, annealed and tempered steel sheet and method of manufacturing the same

(71) Applicant: ArcelorMittal, Luxembourg (LU)

(72) Inventors: Astrid PERLADE, Le Ban-Saint-Martin (FR); Kangying ZHU, Metz (FR); Blandine REMY, Sanry Les Vigy (FR); Michael STOLTZ, Villers la Montagne (FR)

(21) Appl. No.: 19/130,360

(22) PCT Filed: Nov. 13, 2023
(86) PCT No.: PCT/IB2023/061438

§ 371 Date: May 15, 2025

(30) Foreign Application Priority Data
Nov. 18, 2022 (WO) PCT/IB2022/061127

(51) Int. Cl. C22C 38/04; C21D 6/00; C21D 8/0221; C21D 8/0247; C21D 8/0278; C21D 9/46; C22C 38/00; C22C 38/02; C22C 38/14

(52) U.S. Cl. CPC C22C 38/04; C21D 6/005; C21D 8/0226; C21D 8/0263; C21D 8/0278; C21D 9/46; C22C 38/002; C22C 38/02; C22C 38/14; C21D 2211/001; C21D 2211/005; C21D 2211/008

(57) ABSTRACT

A cold rolled, annealed and tempered steel sheet is provided, made of a steel having a composition including, by weight percent C: 0.03-0.18%, Mn: 4.5-10.0%, B: 0.0005-0.005%, Ti 0.010-0.050%, Si 0.1-1.20%, S≤0.010%, P≤0.020%, N≤0.010%, and including optionally one or more of the following elements, in weight percentage Al≤2.5%, Mo≤0.4%, Nb≤0.050%, Cr≤0.5%, V≤0.2%, a remainder of the composition being iron and unavoidable impurities resulting from the smelting, the steel sheet having a microstructure including, in surface fraction, from 0% to 30% of ferrite, from 3% to 30% of retained austenite, with a manganese content in austenite [Mn]_{γ}, expressed in weight percent, such that F_{γ}×([Mn]_{γ}-1.3×% Mn)²>1.00, a balance being tempered martensite.

The present invention relates to a steel sheet having high strength and high ductility properties and to a method to obtain such steel sheet.

### BACKGROUND

To manufacture various items such as parts of body structural members and body panels for automotive vehicles, it is known to use sheets made of DP (Dual Phase) steels or TRIP (Transformation Induced Plasticity) steels.

### SUMMARY OF THE INVENTION

One of the major challenges in the automotive industry is to decrease the weight of vehicles in order to improve their fuel efficiency in view of the global environmental conservation, without neglecting the safety requirements. To meet these requirements, new high strength steels are continuously developed by the steelmaking industry, to have sheets with improved yield and tensile strengths, and good ductility and formability.

One of the developments made to improve mechanical properties is to increase the content of manganese in steels. The presence of manganese helps to increase ductility of steels thanks to the stabilization of austenite. But these steels have a tendency of brittleness. To overcome this problem, elements as boron are added. These boron-added chemistries are very tough at the hot-rolled stage but the hot band is too hard to be further processed. The most efficient way to soften the hot band is batch annealing, but it can lead to a loss of toughness.

The publication WO2022018568 relates to a cold rolled annealed and tempered steel sheet having a combination of good weldability properties and high mechanical properties with a yield strength above or equal to 1000 MPa, a tensile strength TS above or equal to 1450 MPa, a uniform elongation UE above or equal to 6.5% and a total elongation TE above or equal to 9%, wherein the hot rolled steel sheet is annealed before being cold rolled, in order to promote manganese diffusion and to decrease the hardness while maintaining the toughness of the hot-rolled steel sheet. Nevertheless, the method of manufacturing does not allow to obtain a steel sheet with a high hole expansion ratio.

It is an object of the present invention to solve the above-mentioned problem and to provide a steel sheet having a combination of high mechanical properties with a tensile strength TS, a yield strength YS, a uniform elongation UE, a total elongation TE and a hole expansion ratio HE satisfying

$$TS * TE + YS * UE + ( TE * HE * 100 ) > 49000 \% MPa .$$

Preferably, the steel sheet according to the present invention has a carbon equivalent Ceq lower than 0.4%, the carbon equivalent being defined as

$$Ceq = \% C + \% Si / 55 + \% Cr / 20 + \% Mn / 19 - \% Al / 18 + 2.2 \% P - 3.24 \% B - 0.133 * \% Mn * \% Mo$$

with elements being expressed by weight percent.

The present invention provides a hot rolled and annealed steel sheet made of a steel having a composition comprising, by weight percent:

$$C : 0.03 \% - 0.18 \%$$

$$Mn : 4.5 \% - 10. \%$$

$$B : 0.0005 \% - 0.005 \%$$

$$Ti : 0.01 \% - 0.05 \%$$

$$Si : 0.1 - 1.2 \%$$

$$P \leq 0.02 \%$$

$$S \leq 0.01 \%$$

$$N \leq 0.01 \%$$

and comprising optionally one or more of the following elements, in weight percentage:

$$Al \leq 2.5 \%$$

$$Mo \leq 0.4 \%$$

$$Nb \leq 0.05 \%$$

$$Cr \leq 0.5 \%$$

$$V \leq 0.2 \%$$

the remainder of the composition being iron and unavoidable impurities resulting from the smelting, and having a microstructure comprising, in surface fraction:
   from 15% to 50% of retained austenite, wherein more than 6.0% of said retained austenite satisfies [Mn]_{γ}>1.35×(% Mn), [Mn]_{γ} and % Mn being respectively the manganese content in austenite and the nominal manganese content, expressed in weight percent,
less than 1% of carbides.
the balance being ferrite.

The present invention also provides a cold rolled, annealed and tempered steel sheet, made of a steel having a composition as described above, said steel sheet having a microstructure comprising, in surface fraction,
from 0% to 30% of ferrite,
from 3% to 20% of retained austenite F_{γ}, with a manganese content in austenite [Mn]_{γ} and the nominal manganese content % Mn, both expressed in weight percent such that F_{γ}×([Mn]_{γ}−1.3×% Mn)²>1.00,
the balance being tempered martensite.

The present invention also provides a method for producing a cold rolled, annealed and tempered steel sheet, said method comprising the following successive steps:
casting a steel to obtain a slab, said steel having a composition as described above,
heating the slab at a temperature Tᵣₑₕₑₐₜ from 1100° C. to 1300° C.,
hot rolling the heated slab at a finish hot rolling temperature from 800° C. to 1000° C.
coiling the hot rolled steel sheet at a coiling temperature T_{coil} lower than 650° C.,
optionally pickling the hot rolled steel sheet,
annealing the hot rolled steel sheet in at least two steps:
   a first step of annealing at a temperature T₁ from Ac1 to Tc, Tc being the carbides dissolution temperature at equilibrium condition, and maintaining at said T₁ temperature during a holding time t₁ of 0.1 h to 120 h,
   a final step of heating from T₁ to a temperature T_{X}, T_{X} being higher than Tc and below Ac3, and maintaining at said temperature T_{X} for a holding time t_{X} of 0.1 h to 40 h,
in order to obtain a hot rolled and annealed steel sheet,
cooling the hot rolled and annealed steel sheet to room temperature,
cold rolling the hot rolled and annealed steel sheet to obtain a cold rolled steel sheet,
optionally pickling the cold rolled steel sheet,
heating the cold rolled steel sheet to an annealing temperature T_{A} from Tᵢ to (Ac3+100*% C/0.1), Tᵢ being the temperature above which less than 30% of ferrite in surface fraction is formed at the end of this annealing, the rest being austenite, and maintaining at said T_{A} temperature during a holding time t_{A} from 1 s and 3600 s, % C being the nominal carbon content, expressed in weight percent, in order to obtain a cold rolled and annealed steel sheet,
cooling the cold rolled and annealed steel sheet to a temperature below Ms-100° C., at a cooling rate higher than 5° C./s,
reheating the steel sheet to a temperature Tₕ of 150° C. to 450° C., and maintaining at said temperature for a holding time of 1 s to 2 h,
cooling the steel sheet to room temperature in order to obtain a cold rolled, annealed and tempered steel sheet.

### BRIEF DESCRIPTION OF THE DRAWINGS

The invention will now be described in detail and illustrated by examples without introducing limitations, with reference to the appended figures:

FIG. 1 represents a section of the steel sheet which is according to the invention, and

FIG. 2 represents a section of the steel sheet which is not according to the invention.

### DETAILED DESCRIPTION

The present invention will now be described in detail and illustrated by examples without introducing limitations.

The composition of the steel sheet according to the invention will now be described, the content being expressed in weight percent (wt. %).

According to the invention the carbon content is from 0.03% to 0.18% to ensure a satisfactory strength and good weldability properties. Above 0.18% of carbon, weldability of the steel sheet may be reduced. If the carbon content is lower than 0.03%, the content of the tempered martensite is not sufficient to obtain TS above 1450 MPa. In a preferred embodiment of the invention, the carbon content is from 0.05% to 0.18%. In another preferred embodiment of the invention, the carbon content is from 0.10 to 0.18%.

The manganese content is from 4.5% to 10.0%. Above 10.0% of addition, weldability of the steel sheet may be reduced, and the productivity of parts assembly can be reduced. Moreover, the risk of central segregation increases to the detriment of the mechanical properties. The minimum of manganese is defined to stabilize austenite, to obtain, after soaking, the targeted microstructure and strengths. Preferably, the manganese content is from 5.5% to 9.0%, more preferably from 6.0% to 9.0%.

According to the invention, the boron content is from 0.0005% to 0.005% to improve the toughness of the hot rolled steel sheet. Above 0.005%, the formation of boro-carbides at the prior austenite grain boundaries is promoted, making the steel more brittle. In a preferred embodiment of the invention, the boron content is from 0.001% to 0.003%.

Titanium can be added up to 0.050% to provide precipitation strengthening. A minimum of 0.010% of titanium is added in addition to boron to protect boron against the formation of BN.

According to the invention the silicon content is from 0.1% to 1.20% to simplify the process by eliminating the step of pickling the hot rolled steel sheet before the hot band annealing. The maximum addition of silicon content is limited to 1.20% to improve LME resistance. Preferably the maximum silicon content added is 1.0%.

Optionally some elements can be added to the composition of the steel according to the invention.

Aluminum can be added up to 2.5% to decrease the manganese segregation during casting. Aluminum is a very effective element for deoxidizing the steel in the liquid phase during elaboration. Above 2.5% of addition, the weldability of the steel sheet may be reduced, so is castability. Moreover, tensile strength above 1450 MPa is difficult to achieve. Preferably the maximum aluminium content added is 0.5%, more preferably 0.3%, even more preferably 0.1%.

The molybdenum can be added up to 0.4% to decrease the manganese segregation during casting. Above 0.4%, the addition of molybdenum is costly and ineffective in view of the properties which are required. Preferably, a minimum of 0.1% of molybdenum is added to provide resistance to brittleness.

Niobium can optionally be added up to 0.05% to refine the austenite grains during hot-rolling and to provide precipitation strengthening.

Chromium and vanadium can optionally be respectively added up to 0.5% and 0.2% to provide improved strength.

The remainder of the composition of the steel is iron and impurities resulting from the smelting. In this respect, P, S and N at least are considered as residual elements which are unavoidable impurities. Their content is at most 0.020% for P, at most 0.010% for S, and at most 0.010% for N.

The microstructure of the cold rolled, annealed and tempered steel sheet according to the invention will now be described. It contains, in surface fraction:
from 0% to 30% of ferrite,
from 3% to 20% of retained austenite F_{γ}, with a manganese content in austenite [Mn]_{γ} and the nominal manganese content % Mn expressed in weight percent, such that F_{γ}×([Mn]_{γ}−1.3×% Mn)²>1.00, and
the balance being tempered martensite.

The microstructure of the cold rolled, annealed and tempered steel sheet according to the invention contains from 0 to 30% of ferrite. Such ferrite can be formed during the annealing of the hot rolled steel sheet and the annealing of the cold rolled steel sheet, when it takes place at a temperature from Ac1 to Ac3 of the cold rolled steel sheet. When the annealing of the cold rolled steel sheet takes place above Ac3 of the cold rolled steel sheet, no ferrite is present.

The microstructure of the steel sheet according to the invention contains from 3% to 20% of retained austenite (F_{γ}). Below 3% or above 20% of austenite, the uniform and total elongations UE and TE cannot reach the targeted values of 6.5% and 9%.

Such austenite is formed during the intercritical multi step annealing of the hot-rolled steel sheet but also during the annealing of the cold rolled steel sheet. During the intercritical annealing of the hot rolled steel sheet, areas containing a manganese content higher than nominal value (% Mn) and areas containing manganese content lower than nominal value are formed, creating a heterogeneous distribution of manganese. The lower the temperature of the annealing, the higher the manganese content in austenite [Mn]_{γ}. The first step of the multi step annealing, at a temperature T₁ lower than the temperature T_{X} of the final step, thus allows to create areas with a higher amount of manganese, in comparison to the final step of the multi step annealing.

The high amount of manganese in austenite favorizes the stability of austenite. This manganese heterogeneity helps to achieve mechanical properties.

The manganese content in retained austenite [Mn]_{γ}, expressed in weight percent, are such that F_{γ}×([Mn]_{γ}−1.3×% Mn)²>1.00. Below 1.00, the austenite is not stabilized enough to obtain the targeted compromise between high strength, high ductility and high hole expansion ratio. Preferably, the manganese content in retained austenite [Mn]_{γ} is above or equal to 9.6 wt %, more preferably above or equal to 9.7 wt %, even more preferably above or equal to 9.8 wt %.

The rest of the microstructure is tempered martensite. The martensite formed during the cooling after the annealing of the cold rolled steel sheet is tempered during the tempering of the cold rolled steel sheet.

The steel sheet according to the invention has a combination of high mechanical properties with a tensile strength TS, a yield strength YS, a uniform elongation UE, a total elongation TE and a hole expansion ratio HE satisfying

$$TS * TE + YS * UE + ( TE * HE * 100 ) > 49000 \% MPa .$$

Preferably, the steel sheet has a TS above 1450 MPa, a YS above 1000 MPa, a uniform elongation above 6.5% and a total elongation above or equal to 9.0%. Preferably, the steel sheet has a hole expansion ratio HE above 15%, more preferably above 18%.

Preferably, the steel sheet according to the invention has a carbon equivalent Ceq lower than 0.4%, the carbon equivalent being defined as

$$Ceq = C \% + Si \% / 55 + Cr \% / 20 + Mn \% / 19 - Al \% / 18 + 2.2 P \% - 3.24 B \% - 0.133 * Mn \% * Mo \%$$

with elements being expressed by weight percent.

The steel sheet according to the invention can be produced by any appropriate manufacturing method and the person skilled in the art can choose one. It is however preferred to use the method according to the invention comprising the following steps.

A semi-product able to be further hot rolled, is provided with the steel composition described above. The semi product is heated to a temperature from 1100° C. to 1300° C., so to make it possible to ease hot rolling, with a final hot rolling temperature FRT from 800° C. to 1000° C. Preferably, the FRT is from 800° C. to 900° C.

The hot-rolled steel sheet is then cooled and coiled at a temperature T_{coil} below 650° C., and preferably from 300 to 550° C., in order to obtain a hot rolled and coiled steel sheet.

The hot rolled and coiled steel sheet is then cooled to room temperature and can be pickled.

The hot rolled steel sheet is then annealed in at least two steps (hereinafter the multi step annealing) to promote manganese inhomogeneous repartition:

In a first step, the hot rolled steel sheet is heated to an annealing temperature T₁ from Ac1 to Tc, Tc being the carbides dissolution temperature at equilibrium condition that can be determined through thermodynamic calculations done with the use of a software like Thermo-Calc®.

The steel sheet is maintained at said T₁ temperature during a holding time t₁ from 0.1 h and 120 h, in order to form at least 10% of austenite according to Thermo-Calc® calculation at equilibrium condition, the rest being ferrite and carbides.

In a final step, the hot rolled steel sheet is heated from T₁ to a temperature T_{X} higher than Tc and below Ac3, preferably higher than Tc and below 680° C., and maintained at said temperature for a holding time t_{X} of 0.1 h to 40 h, in order to obtain a hot rolled and annealed steel sheet having a microstructure after cooling at room temperature, comprising in surface fraction:
from 15% to 50% of retained austenite, wherein more than 6.0% of said retained austenite satisfy [Mn]_{γ}>1.35×(% Mn), [Mn]_{γ} and % Mn being respectively the manganese content in austenite and the nominal manganese content, expressed in weight percent,
less than 1% of carbides,
the balance being ferrite.

Preferably, more than 6.5% of said retained austenite satisfy [Mn]_{γ}>1.35×% Mn, more preferably more than 7.0%, even more preferably more than 8.5%.

This multi step annealing promotes manganese diffusion and formation of inhomogeneous manganese distribution. Moreover, this heat treatment allow to decrease the hardness and to maintain the toughness of the hot-rolled steel sheet.

In a preferred embodiment of the invention, one additional step of annealing can be added between the first step and the final step of annealing. In this additional step, the steel sheet is heated from T₁ to a temperature T₂ from T₁ to T_{X}, and maintained at said temperature T₂ for a holding time t₂ from 0.1 h to 120 h, before being heated to temperature T_{X}.

In another preferred embodiment of the invention, up to three additional steps of annealing can be added between the first step and the final step of annealing.

The hot rolled and heat-treated steel sheet is then cooled to room temperature and can be pickled to remove oxidation.

The hot rolled and heat-treated steel sheet is then cold rolled at a reduction rate from 20% to 80%.

The cold rolled steel sheet is then submitted to annealing at a temperature T_{A} from Tᵢ to (Ac3+100*% C/0.1) for a holding time t_{A} of 1 s to 3600 s, Tᵢ being the temperature above which less than 30% of ferrite, in surface fraction, is remained at the end of this annealing, the rest being austenite, Tᵢ being determined through dilatometry tests and metallography analysis, Ac3 being determined by dilatometry for the cold rolled steel sheet and % C referring to the nominal concentration in carbon. Beyond (Ac3+100*% C/0.1), the austenite formed at the end of the soaking will lead to a too low retained austenite stabilized during the cooling to room temperature. Preferably, T_{A} is from 750° C. to 850° C. Preferably, t_{A} is from 100 to 1000 s. Such annealing can be performed by continuous annealing.

The cold rolled and annealed steel sheet is then quenched below Ms−100° C. at an average cooling rate of at least 5° C./s. Part of the austenite present at the end of the soaking will be turned into fresh martensite during this cooling. Preferably, the average cooling rate is higher than 10° C./s, in order to promote the martensite formation.

After quenching, the steel sheet is submitted to a tempering step at a temperature Tₕ from 150° C. to 450° C., and maintained at said Tₕ temperature for a holding time tₕ of 1 s to 2 h. Preferably, Tₕ is from 150° C. and 300° C., more preferably from 150° C. to 280° C., even more preferably form 150° C. to 250° C. Preferably tₕ is from to 100 s to 1800 s, more preferably from 100 s to 500 s.

The fresh martensite is transformed into tempered martensite at the end of this tempering step.

The cold rolled, annealed and tempered steel sheet is then cooled to room temperature. It can then be coated by any suitable process including hot-dip coating, electrodeposition or vacuum coating of zinc or zinc-based alloys or of aluminum or aluminum based alloys.

The invention will be now illustrated by the following examples, which are by no way limitative.

### EXAMPLES

Four grades, whose compositions are gathered in table 1, were cast in semi-products and processed into steel sheets.

TABLE 1
Compositions

| | | | | | | | | | | | Ac1 | Ac3 | Ms | T₁ | Tc | |
|---|---|---|---|---|---|---|---|---|---|---|---|---|---|---|---|---|
| Steel | C | Mn | Si | Al | Mo | Ti | B | S | P | N | (° C.) | (° C.) | (° C.) | (° C.) | (° C.) | Ceq |
| A | 0.142 | 7.10 | 0.80 | 0.03 | 0.24 | 0.023 | 0.0024 | 0.0035 | 0.012 | 0.0037 | 550 | 750 | 260 | 740 | 630 | 0.32 |
| B | 0.147 | 7.10 | 0.80 | 0.03 | 0.24 | 0.023 | 0.0024 | 0.0036 | 0.013 | 0.0035 | 550 | 750 | 260 | 740 | 630 | 0.33 |
| C | 0.150 | 7.15 | 0.80 | 0.03 | 0.25 | 0.023 | 0.0024 | 0.0037 | 0.012 | 0.0038 | 550 | 750 | 260 | 740 | 630 | 0.32 |
| D | 0.147 | 6.97 | 0.30 | 0.03 | 0.21 | 0.022 | 0.002 | 0.002 | 0.011 | 0.0044 | 550 | 750 | 263 | 740 | 630 | 0.34 |

The tested compositions are gathered in the following table wherein the element contents are expressed in weight percent.

Ac1, Ac3, Ms and Ti temperatures have been determined through dilatometry tests and metallography analysis. Tc has been determined through thermodynamical calculations.

TABLE 2
Process parameters of the cold rolled, annealed and tempered steel sheets

| | | | | | | | | Cold | | | | | | |
|---|---|---|---|---|---|---|---|---|---|---|---|---|---|---|
| | | | | | | | | rolling | Annealing | | | Cooling | | |
| | | Hot band annealing (HBA) | | | | | | reduction | (Ac3 + | | | rate | Tempering | |
| Trials | Steel | T₁(° C.) | t₁(h) | T₂(° C.) | t₂(h) | T_{X}(° C.) | t_{X}(h) | (%) | 100*% C/0.1) | T_{A}(° C.) | t_{A}(s) | (° C./s) | Tₕ(° C.) | tₕ(s) |
| 1 | A | 550 | 10 | 600 | 10 | 650 | 10 | 50 | 892 | 800 | 120 | 20 | 200 | 220 |
| 2 | A | 550 | 10 | 600 | 10 | 650 | 10 | 50 | 892 | 820 | 120 | 20 | 200 | 220 |
| 3 | A | 650 | 10 | — | — | — | — | — | 892 | — | — | — | — | — |
| 4 | B | 640 | 10 | — | — | — | — | 50 | 897 | 800 | 120 | 20 | 200 | 220 |
| 5 | B | 640 | 10 | — | — | — | — | 50 | 897 | 820 | 120 | 20 | 200 | 220 |
| 6 | C | 670 | 10 | — | — | — | — | 50 | 900 | 800 | 120 | 20 | 200 | 220 |
| 7 | C | 670 | 10 | — | — | — | — | 50 | 900 | 820 | 120 | 20 | 200 | 220 |
| 8 | D | 650 | 40 | — | — | — | — | 50 | 897 | 760 | 120 | 2 | 200 | 220 |
| 9 | D | 650 | 40 | — | — | — | — | 50 | 897 | 780 | 120 | 2 | 200 | 220 |
| 10 | D | 650 | 40 | — | — | — | — | 50 | 897 | 800 | 120 | 2 | 200 | 220 |

Underlined values: not according to the invention

Steel semi-products, as cast, were heated at 1200° C., hot rolled with a finish rolling temperature of 850° C. and then coiled at a temperature of 450° C.

In trials 1 and 2, the hot rolled steel sheets are then annealed in three steps: a first step of annealing at a temperature T₁, and maintained at said temperature for a holding time t₁, a second step of heating from T₁ to a temperature T₂ for a holding time t₂ and a final step of annealing from T₂ to a temperature T_{X} for a holding time t_{X}.

In trials 3-10, the hot rolled steel sheets are then annealed in one step at a temperature T₁, and maintained at said temperature for a holding time t₁.

Except in trial 3, the steel sheets are then cold rolled, before being annealed at a temperature T_{A} during a holding time t_{A}. The cold rolled and annealed steel sheets are then cooled to a temperature of 30° C., and reheated to a temperature Tₕ, and maintained at said temperature for a holding time tₕ, before being cooled to room temperature.

The following specific conditions to obtain the cold rolled, annealed and tempered steel sheets were applied:

The hot rolled and annealed steel sheets were analyzed before the cold rolling step, and the corresponding microstructure and properties are gathered in Table 3 and Table 4 respectively.

TABLE 3
Microstructure of the hot rolled and annealed steel sheet

| | Austenite (%) | | | |
|---|---|---|---|---|
| | Total | Proportion of austenite satisfying | | |
| | content | [Mn]_{γ} > 1.35 × (% Mn) | Ferrite | Carbides |
| Trials | (%) | (%) | (%) | (%) |
| 1 | 41 | 10.5 | 58.8 | 0.2 |
| 2 | 41 | 10.5 | 58.8 | 0.2 |
| 3 | 42 | 5.5 | 57.85 | 0.15 |
| 4 | 38 | 3 | 61.75 | 0.25 |
| 5 | 38 | 3 | 61.75 | 0.25 |
| 6 | 46 | 5.3 | 53.85 | 0.15 |
| 7 | 46 | 5.3 | 53.85 | 0.15 |
| 8 | 43 | 2 | 56.8 | 0.2 |
| 9 | 43 | 2 | 56.8 | 0.2 |
| 10 | 43 | 2 | 56.8 | 0.2 |

Underlined values: do not match the targeted values

The phase percentages of the microstructures of the obtained hot rolled and annealed steel sheet were determined.

The surface fractions of phases in the microstructure are determined through the following method: a specimen is cut from the hot rolled and annealed steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the surface fraction of retained austenite is performed thanks to X-ray diffraction.

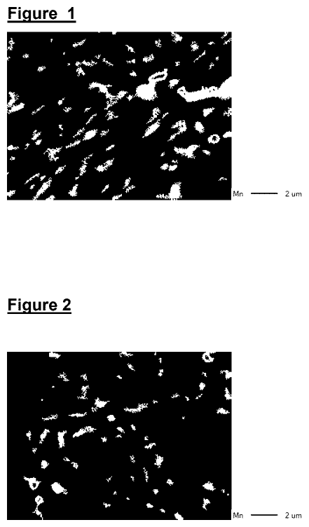

FIG. 1 and FIG. 2 represent a section of the hot rolled and annealed steel sheet of trial 1 and trial 3 respectively. The black area corresponds to an area with lower amount of manganese, the grey area corresponds to a higher amount of manganese.

The figures are obtained through the following method: a specimen is cut at ¼ thickness from the hot rolled and annealed steel sheet and polished.

The section is afterwards characterized through electron probe micro-analyzer, with a Field Emission Gun (“FEG”) at a magnification greater than 10000× to determine the manganese amounts. Three maps of 10 μm*10 μm of different parts of the section were acquired. These maps are composed of pixels of 0.01 μm². Manganese amount in weight percent is calculated in each pixel. Pixels with Mn content [Mn]_{γ} higher than 1.35×(% Mn) correspond to white areas. Black areas are areas with [Mn]_{γ} lower than 1.35×(% Mn).

This multi step annealing promotes manganese diffusion in austenite and formation of inhomogeneous manganese distribution: the repartition of manganese is heterogeneous with areas with low manganese content and areas with high manganese content. Moreover, the lower the annealing temperature, the higher the manganese content in austenite [Mn]_{γ}. The first step of the multi step annealing, is performed at a lower temperature than the final step, thus allows to create areas with higher amount of manganese, in comparison to the final step of the multi step annealing.

The high amount of manganese in austenite favorizes the stability of austenite. This manganese heterogeneity helps to achieve mechanical properties.

In trial 3 the steel sheet was submitted to a one step hot band annealing, with temperature and time parameters equal to the final step of the multi-step annealing of trials 1 and 2. This triggers a Mn-enriched austenite area, satisfying [Mn]_{γ}>1.35×(% Mn) (%), in the hot rolled and annealed steel sheet much lower than in trials 1 and 2.

Moreover, this heat treatment allows improving the toughness of the hot-rolled steel and annealed steel sheet as shown in Table 4.

TABLE 4
Properties of the hot rolled and annealed steel sheet

| Trials | Charpy energy (J/mm²) |
|---|---|
| 1 | 0.70 |
| 2 | 0.70 |
| 4 | 0.59 |
| 5 | 0.59 |
| 6 | 0.59 |
| 7 | 0.59 |
| 8 | 0.50 |
| 9 | 0.50 |
| 10 | 0.50 |

The toughness of the steel sheets of trials 4-10 are lower than the toughness of the steel sheet of trials 1 and 2 which have been subjected to the multi step annealing.

The Charpy impact energy has been measured at 20° C. according to Standard ISO 148-1:2006 (F) and ISO 148-1:2017(F).

The cold rolled, annealed and tempered steel sheets were then analyzed, and the corresponding microstructure and properties are gathered in Table 5 and in Table 6 respectively.

TABLE 5
Microstructure of the cold rolled,
annealed and tempered steel sheet

| | | Retained | | F_{γ} × | Tempered |
|---|---|---|---|---|---|
| | Ferrite | austenite F_{γ} | [Mn]_{γ} | ([Mn]_{γ} − 1.3 × | martensite |
| Trials | (%) | (%) | (% wt) | % Mn)² | (%) |
| 1 | 0 | 10 | 9.8 | 3.25 | 90 |
| 2 | 0 | 8 | 9.8 | 2.60 | 92 |
| 4 | 0 | 7 | 9.4 | 0.20 | 93 |
| 5 | 0 | 6 | 9.3 | 0.03 | 94 |
| 6 | 0 | 9 | 9.0 | 0.78 | 91 |
| 7 | 0 | 7 | 9.0 | 0.61 | 93 |
| 8 | 0 | 14 | 9.2 | 0.27 | 86 |
| 9 | 0 | 12 | 9.1 | 0.02 | 88 |
| 10 | 0 | 9 | 9.1 | 0.01 | 91 |

Underlined values: not according to the invention

The phase percentages of the microstructures of the obtained cold rolled, annealed and tempered steel sheet were determined.

The surface fractions of phases in the microstructure are determined through the following method: a specimen is cut from the cold rolled annealed and tempered steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of tempered martensite and ferrite is performed thanks to SEM observations after Nital or Picral/Nital reagent etching.

The determination of the volume fraction of retained austenite F_{γ} is performed thanks to X-ray diffraction.

TABLE 6
Mechanical properties of the cold rolled
annealed and tempered steel sheet

| | YS | TS | UE | TE | HE | TS*TE + YS*UE + |
|---|---|---|---|---|---|---|
| Trials | (MPa) | (MPa) | (%) | (%) | (%) | TE*HE*100 (% MPa) |
| 1 | 1424 | 1640 | 8.5 | 10.8 | 24 | 55736 |
| 2 | 1410 | 1624 | 7.9 | 10.2 | 22 | 50144 |
| 4 | 1452 | 1640 | 7.1 | 9.4 | 24 | 48285 |
| 5 | 1394 | 1606 | 6.3 | 8.6 | 28 | 46674 |
| 6 | 1435 | 1639 | 7.1 | 9.0 | 19 | 42040 |
| 7 | 1366 | 1614 | 7.4 | 9.6 | 21 | 45763 |
| 8 | 1464 | 1628 | 7.1 | 10.1 | 13 | 39967 |
| 9 | 1426 | 1617 | 8 | 9.9 | 14 | 41276 |
| 10 | 1414 | 1608 | 7.6 | 9.4 | 14 | 39022 |

Mechanical properties of the obtained cold rolled, annealed and tempered steel sheets were determined and gathered in the following table.

The yield strength YS, the tensile strength TS and the uniform and total elongation UE, TE are measured according to ISO standard ISO 6892-1, published in October 2009. The hole expansion ratio HE is measured according to ISO standard 16630:2009.

Trials 1 and 2 were submitted to a multi step annealing, which allow to obtain a high amount of Mn-enriched austenite in the hot rolled and annealed steel sheet, as shown in Table 3. Thanks to this enrichment, after being submitted to cold rolling, annealing and tempering, the microstructure still contains an Mn-enriched area which allow to obtain higher fraction of stabilized austenite, highlighted by the formula F_{γ}×([Mn]_{γ}−1.3×% Mn)²>1.00. This leads to a good compromise ductility and strength.

By comparison, in trial 3 the steel sheet was submitted to a one step hot band annealing, with temperature and time parameters equal to the final step of the multi-step annealing of trials 1 and 2. This triggers a Mn-enriched austenite area in the hot rolled and annealed steel sheet much lower than in trials 1 and 2 as shown in Table 3 and leads to a lower ductility and strength compromise.

In trials 4 to 10, the steel sheets were submitted to a one step hot band annealing. The Mn-enriched austenite area in the hot rolled steel sheet is then much lower than in trials 1 and 2 as shown in Table 3. This leads to a less stabilized austenite, characterized by the formula F_{γ}×([Mn]_{γ}−1.3×% Mn)²>1.00, and resulting to a bad compromise strength/ductility/hole expansion ratio, with TS*TE+YS*UE+(TE*HE*100)<49000% MPa.

What is claimed is:

1-6. (canceled)

7: A hot rolled and annealed steel sheet made of a steel having a composition comprising, by weight percent:
$$C : 0.03 \% - 0.18 \%$$
$$Mn : 4.5 \% - 10. \%$$
$$B : 0.0005 \% - 0.005 \%$$
$$Ti : 0.01 \% - 0.05 \%$$
$$Si : 0.1 - 1.2 \%$$
$$P \leq 0.02 \%$$
$$S \leq 0.01 \%$$
$$N \leq 0.01 \%$$
and one or more of the following optional elements, in weight percentage:
$$Al \leq 2.5 \%$$
$$Mo \leq 0.4 \%$$
$$Nb \leq 0.05 \%$$
$$Cr \leq 0.5 \%$$
$$V \leq 0.2 \%$$
a remainder of the composition being iron and unavoidable impurities resulting from processing; and
having a microstructure comprising, in surface fraction:
from 15% to 50% of retained austenite, wherein more than 6.0% of said retained austenite satisfies [Mn]_{γ}>1.35×(% Mn), [Mn]_{γ} and % Mn being respectively the manganese content in austenite and the nominal manganese content, expressed in weight percent;
less than 1% of carbides; and
a balance being ferrite.

8: A cold rolled, annealed and tempered steel sheet, having a composition comprising, by weight percent:
$$C : 0.03 \% - 0.18 \%$$
$$Mn : 4.5 \% - 10. \%$$
$$B : 0.0005 \% - 0.005 \%$$
$$Ti : 0.01 \% - 0.05 \%$$
$$Si : 0.1 - 1.2 \%$$
$$P \leq 0.02 \%$$
$$S \leq 0.01 \%$$
$$N \leq 0.01 \%$$
and one or more of the following optional elements, in weight percentage:
$$Al \leq 2.5 \%$$
$$Mo \leq 0.4 \%$$
$$Nb \leq 0.05 \%$$
$$Cr \leq 0.5 \%$$
$$V \leq 0.2 \%$$
a remainder of the composition being iron and unavoidable impurities resulting from processing; and
having a microstructure comprising, in surface fraction,
from 0% to 30% of ferrite;
from 3% to 20% of retained austenite F_{γ}, with a manganese content in austenite [Mn]_{γ} and the nominal manganese content % Mn, both expressed in weight percent such that F_{γ}×([Mn]_{γ}−1.3×% Mn)²>1.00; and
a balance being tempered martensite.

9: The cold rolled, annealed and tempered steel sheet as recited in claim 8 wherein the cold rolled, annealed and tempered steel sheet has a tensile strength TS, a yield strength YS, a uniform elongation UE, a total elongation TE and a hole expansion ratio HE satisfying the following equation: (TS*TE)+(YS*UE)+(TE*HE*100)>49000 MPa %.

10: A method for producing a cold rolled, annealed and tempered steel sheet, said method comprising the following successive steps:
casting a steel to obtain a slab, the steel having a composition comprising, by weight percent:
$$C : 0.03 \% - 0.18 \%$$
$$Mn : 4.5 \% - 10. \%$$
$$B : 0.0005 \% - 0.005 \%$$
$$Ti : 0.01 \% - 0.05 \%$$
$$Si : 0.1 - 1.2 \%$$
$$P \leq 0.02 \%$$
$$S \leq 0.01 \%$$
$$N \leq 0.01 \%$$
and one or more of the following optional elements, in weight percentage:
$$Al \leq 2.5 \%$$
$$Mo \leq 0.4 \%$$
$$Nb \leq 0.05 \%$$
$$Cr \leq 0.5 \%$$
$$V \leq 0.2 \%$$
a remainder of the composition being iron and unavoidable impurities resulting from processing;
heating the slab at a temperature Tᵣₑₕₑₐₜ from 1100° C. to 1300° C.;
hot rolling the heated slab at a finish hot rolling temperature from 800° C. to 1000° C.;
coiling the hot rolled steel sheet at a coiling temperature T_{coil} lower than 650° C.;
optionally pickling the hot rolled steel sheet;
annealing the hot rolled steel sheet in at least two steps:
a first step of annealing at a temperature T₁ from Ac1 to Tc, Tc being a carbides dissolution temperature at equilibrium condition, and maintaining the hot rolled steel sheet at the T₁ temperature for a holding time t₁ of 0.1 h to 120 h,
a final step of heating from T₁ to a temperature T_{X}, T_{X} being higher than Tc and below Ac3, and maintaining the hot rolled steel sheet at the temperature T_{X} for a holding time t_{X} of 0.1 h to 40 h,
in order to obtain a hot rolled and annealed steel sheet;
cooling the hot rolled and annealed steel sheet to room temperature;
cold rolling the hot rolled and annealed steel sheet to obtain a cold rolled steel sheet;
optionally pickling the cold rolled steel sheet;
heating the cold rolled steel sheet to an annealing temperature T_{A} from Tᵢ to (Ac3+100*% C/0.1), Tᵢ being a temperature above which less than 30% of ferrite in surface fraction is formed at the end of this annealing, a rest being austenite, and maintaining the cold rolled steel sheet at the T_{A} temperature for a holding time t_{A} from 1 s and 3600 s, % C being the nominal carbon content, expressed in weight percent, in order to obtain a cold rolled and annealed steel sheet;
cooling the cold rolled and annealed steel sheet to a temperature below Ms−100° C., at a cooling rate higher than 5° C./s;
reheating cold rolled and annealed steel sheet to a temperature Tₕ of 150° C. to 450° C., and maintaining cold rolled and annealed steel sheet at the temperature Tₕ for a holding time of 1 s to 2 h; and
cooling the steel sheet to room temperature in order to obtain a cold rolled, annealed and tempered steel sheet.

11: The method as recited in claim 19 wherein the annealing of the hot rolled steel sheet comprises an additional step of annealing between the first and final steps of annealing of the hot rolled steel sheet, the hot rolled steel sheet being heated from T₁ to a temperature T₂ higher than T₁ and lower than T_{X}, and maintained the hot rolled steel sheet at the temperature T₂ for a holding time t₂ from 0.1 h and 120 h, before being heated in the final step from T₂ to Tₓ.

12: A method for manufacturing of structural parts of vehicles comprising employing the hot rolled and annealed steel sheet as recited in claim 7 as a structural part of a vehicle.

13: A method for manufacturing of structural parts of vehicles comprising employing the cold rolled, annealed and tempered steel sheet as recited in claim 8 as a structural part of a vehicle.

14: A method for manufacturing of structural parts of vehicles comprising employing the cold rolled, annealed and tempered steel sheet manufactured according to claim 10 as a structural part of a vehicle.
